(19) United States
(12) Patent Application Publication
(10) Pub. No.: US 2020/0050215 A1
(43) Pub. Date: Feb. 13, 2020

(54) METHOD FOR CONTROLLING CLEANING DEVICES

(71) Applicant: Henkel AG & Co. KGaA, Duesseldorf (DE)

(72) Inventors: ARND KESSLER, Monheim am Rhein (DE); CHRISTIAN NITSCH, Duesseldorf (DE); LARS ZUECHNER, Langenfeld (DE); ALEXANDER MUELLER, Monheim (DE); GEORG WAWER, Wien (AT); ALEXANDRA VASSILEVA, Duesseldorf (DE); CLEMENS ARTH, Graz (AT)

(73) Assignee: Henkel AG & Co. KGaA, Duesseldorf (DE)

(21) Appl. No.: 16/478,968

(22) PCT Filed: Feb. 22, 2018
(86) PCT No.: PCT/EP2018/054321

§ 371 Date: Jul. 18, 2019

(30) Foreign Application Priority Data
May 2, 2017 (DE) 10 2017 207 341.1

(51) Int. Cl. G05D 1/02; A47L 11/40

(52) U.S. Cl. CPC G05D 1/0297; A47L 11/4011; A47L 2201/06; G05D 2201/0203; A47L 2201/04; G05D 1/0246

(57) ABSTRACT

A method includes acquiring position information and/or orientation information from at least two cleaning machines with the position information and/or the orientation information being indicative of a position and/or orientation of the at least two cleaning machines in an area to be cleaned and/or cared for, acquiring soiling information indicative of a location or area that is to be cleaned and/or cared for within the area to be cleaned or cared for, determining control information based at least partially on the acquired position information and/or orientation information and on the acquired soiling information, and outputting or triggering of an output of the control information thereby determined. A corresponding device and system are also disclosed.

### CROSS-REFERENCE TO RELATED APPLICATIONS

This application is a U.S. National-Stage entry under 35 U.S.C. § 371 based on International Application No. PCT/EP2018/054321, filed Feb. 22, 2018, which was published under PCT Article 21(2) and which claims priority to German Application No. 10 2017 207 341.1, filed May 2, 2017, which are all hereby incorporated in their entirety by reference.

### TECHNICAL FIELD

The present disclosure relates to methods and devices, i.e., machines, with which cleaning devices carry out cleaning and/or care of a certain area, for example, within a household, based on certain control information.

### BACKGROUND

A known problem in cleaning using automatic and/or autonomous cleaning machines, such as cleaning robots or drones, is that the cleaning often does not yield a result that is satisfactory for the user.

In particular with simultaneous use of a plurality of automatic and/or autonomous cleaning machines, it is a disadvantage that such cleaning always takes place independently of one another. For example, surfaces that have already been cleaned are therefore sometimes cleaned redundantly.

### SUMMARY

Against the background of the state of the art presented here, the object of the present disclosure is thus to at least partially reduce or prevent the problems that have been described, i.e., to improve the cleaning result, in particular when using a plurality, i.e., at least two, automatic and/or autonomous cleaning machines.

This object is achieved in the present disclosure by the subject matter according to any one of the independent claims.

According to a first aspect of the present disclosure, a method is carried out by one or more devices, for example, wherein the method comprises: detecting position information and/or orientation information from at least two cleaning machines, wherein the position information and/or orientation information is indicative of a position and/or orientation of the at least two cleaning machines in an area that is to be cleaned and/or to receive care; acquiring soiling information, wherein the soiling information is indicative of a location or area to be cleaned and/or receive care within the area to be cleaned and/or to receive care; determining control information based at least partially on the position information and/or orientation information detected and on the detected soiling information; and outputting or triggering an output of the control information thereby determined.

According to a second aspect of the present disclosure, a device is described which is equipped or comprises corresponding features for carrying out and/or controlling a method according to the first aspect. Devices of the method according to the first aspect are or comprise in particular one or more devices according to the second aspect.

According to a third aspect, an example of a system is described, comprising a plurality of devices according to the second aspect, in particular at least one processing unit and at least two cleaning machines, which together are equipped to carry out an example of a method as contemplated herein.

According to another embodiment, a computer program is also described, comprising program instructions which prompt a processor to carry out and/or control a method as contemplated herein when the computer program is running on the processor.

Furthermore, an example of a computer-readable memory medium, which contains an example of a computer program is described.

A suitable combination, i.e., at least two cleaning machines (e.g., a robot and/or a drone) for automatic in particular autonomous cleaning machines can achieve a satisfactory cleaning result by cooperation of the at least two automatic, in particular autonomous cleaning machines. The cooperation of the at least two cleaning machines can be accomplished, for example, by a network circuit, for example, by a wireless communications link.

Within the scope of the present disclosure, an automatic and/or autonomous cleaning machine—referred to below as a cleaning machine—is understood in particular to refer to a cleaning machine and/or a care machine, which is capable of cleaning and/or providing care for a surface in a household, for example, at least partially automatically, i.e., without involving the labor of a user. Examples of surfaces in a household to be cleaned and/or to provide care for include floors, walls, ceilings, windows, carpets, terrace surfaces, lawn surfaces, and/or the surfaces of swimming pools.

Within the scope of the present disclosure, the use of a number of different types of cleaning machines designed for implementation in autonomous operation is described. The intended purpose of these cleaning machines designed for autonomous operation is usually to service and clean the usual surfaces encountered in a household (e.g., floors, windows, to name but a few examples), cleaning surfaces in swimming pools or caring for a lawn surface. In addition a method for position and/or orientation detection based on a detected position information and/or orientation information and control (e.g., navigation) of the individual cleaning machines may be used in an example of an embodiment of the present disclosure according to all aspects in order to achieve an improved cleaning result for a location or an area to be cleaned and/or cared within an area to be cleaned and/or cared for (e.g., in a household and/or garden). Furthermore, for example, this makes it possible to optimize the consumption of materials (e.g., cleaning and/or care features), the noise burden, power consumption and/or wear on the individual cleaning machines.

Position information and/or orientation information about at least two cleaning machines is detected. The position information and/or orientation information is indicative of the position and/or orientation of a clean machine in an area to be cleaned and/or cared for. The position information and/or orientation information can be supplied by the respective cleaning machine, for example, the respective cleaning machine has a corresponding sensor for detecting and/or orientation information. Next the respective detected position information and/or orientation information can be transmitted from the respective cleaning machine to another device.

Soiling information is detected. The soiling information is indicative of a location or area that is to be cleaned and/or cared for within the area to be cleaned and/or cared for. The soiling information may be indicative of a type and/or quantity of soiling. The location or area to be cleaned and/or cared for may be a customary surface in a household, for example, such as floors and/or windows. Furthermore, the area to be cleaned and/or cared for may be a surface in a garden, for example, such as the water surface of a swimming pool and/or the surface of a terrace or balcony or a lawn surface.

Control information is determined at least partially based on the detected position information and/or orientation information and on the detected soiling information. The control information may be indicative of an instruction for one or more of the at least two cleaning machines, so that the cleaning machine carries out a cleaning and/or care of a soiled and/or uncared for area that is to be cleaned and/or cared for, based on the control information.

The control information determined is output and/or its output is triggered. For example, the control information is displayed for a user on a display device, so that an area identified as an area to be cleaned and/or cared for, for example, is provided for the user, in particular being presented visually and/or acoustically. The user can then carry out a cleaning and/or care operation in accordance with the control parameters displayed on the display device in that, for example, a cleaning machine is referenced accordingly by the user. For example, a plurality of set of control information may be made available to the user (e.g., by being displayed on a display device), such as control information for a plurality of cleaning machines.

Alternatively or additionally, the control information may be transmitted to a cleaning machine, so that the implementation of a cleaning and/or care operation is triggered as an action. This action may be to control a cleaning machine, for example, such as a robot and/or a drone. To do so, for example, the control information that has been ascertained can be transmitted to the cleaning machine by a communication device equipped accordingly, for example, by a hardwired or wireless communication link. The wireless communication link may be formed according to the Bluetooth, Zigbee, WAN (e.g., LoRa or Sigfox), or WLAN standard. For example, the control information may be transmitted to a cleaning machine, which receives the control machine and wherein the user need only start the cleaning machine. It is likewise conceivable that the cleaning machine will automatically carry out the cleaning and/or care when the control information is output and transmitted to the cleaning machine. The cleaning machine may have a dosing device for a cleaning agent, for example, in order to automatically supply the type of cleaning agent and the dosing of cleaning agent in accordance with the control information. As a result, in addition to improving the user friendliness of the method, this also improves the consumption of resources, such as the cleaning agent used for cleaning and/or care.

In an exemplary embodiment, cleaning and/or care of the location or the area is/are carried out automatically in particular, based at least partially on the control information of at least one of the at least two cleaning machines.

According to an exemplary embodiment of the method according to the first aspect, the determination of the control information is carried out and/or controlled by a processing unit. The processing unit may be, for example, a home appliance controller arranged centrally in the household (e.g., installed there), such as a desktop computer, for example, a central control unit, a server or a home automation system. Additionally or alternatively, the processing unit may be a smart device (mobile, for example) such as, for example, a smartphone, a tablet, or a smartwatch. Furthermore, the processing unit may be a home appliance controller not arranged centrally in the household such as, for example, a server or a server cloud connected via a communication link. For example, this server or the server cloud may be connected by the Internet.

In an exemplary embodiment of the method according to the first aspect, the control information determined may be output via a communication interface and/or its output may be triggered. The communication interface may be designed to be wireless, for example, such as a communication interface according to the WLAN, Zigbee, WAN (e.g., LoRa or Sigfox), Bluetooth standard, or a mobile radio standard, such as GPRS, 3G and/or LTE but may also be designed to be hardwired such as a communication interface according to the Ethernet standard. As already explained above, the control information may be transmitted to a cleaning machine via the communication interface, which receives the control information, and wherein the user need only start the cleaning machine. It is likewise conceivable for the cleaning machine to carry out the cleaning and/or care automatically with the output of the control information and the receipt of the control information transmitted via the communication interface.

According to an exemplary embodiment of the method according to the first aspect, the soiling information is detected by one of the at least two cleaning machines. For example, one of the at least two cleaning machines may detect soiling information, for example, because this cleaning machine is situated near the soiling. The control information can then be determined, based at least partially on the soiling information acquired by the cleaning machine, such that either the cleaning machine, which has acquired the soiling information, will carry out the cleaning and/or care according to the control information of the soiling as an action. Alternatively, another cleaning machine, which has not acquired the soiling information, may carry out the cleaning and/or care according to the control information about the soiling as an action. This may be the case, for example, when the cleaning machine, which has acquired the soiling information, is not designed for eliminating the soiling according to the type of soiling, so it cannot eliminate the soiling, for example. Furthermore, the cleaning machine, which acquired the soiling information, for example, may have a low energy status, so that the remaining energy of the cleaning machine is not sufficient to eliminate the soiling. To be able to achieve the fastest possible elimination of soiling, for example, it may be recommended that another cleaning machine, which did not acquire the soiling information, will eliminate the soiling in such cases.

In an exemplary embodiment of the method according to the first aspect, the control information is also determined based on a certain planning information, wherein, for example, the planning information is indicative of predicted locations or areas to be cleaned and/or cared for within the area to be cleaned and/or cared for. The location or area to be cleaned and/or cared for may be in a house, in a garden, in a building or may also be publicly accessible, such as a retail center, a public park or the like.

For example, the planning information may be indicative of a recurring cleaning and/or care operation, for example, that will fall due at regular intervals (e.g., predefined intervals). For example, the planning information may be determined by a user; for example, the input may take place by an input device, such as a keypad, a touch-sensitive display or the like, for example. For example, the user may specify that one or more surfaces are to be cleaned and/or cared for once a week, daily or monthly, for example, or even several times a day. This may be taken into account in determining the control information, on the basis of which the at least two cleaning machines, for example, will carry out a cleaning and/or care operation. The efficiency of the cleaning and/or care operation carried out by the at least two cleaning machines can be increased in this way.

According to an exemplary embodiment of the method according to the first aspect, the planning information is determined, based on at least one of the following parameters:
(i) a cleaning performance of the respective cleaning machine;
(ii) a consumption of materials by the respective cleaning machine;
(iii) a required time of the respective cleaning machine to clean and/or care for the location or area to be cleaned and/or cared for within the area to be cleaned and/or cared for;
(iv) an energy consumption of the respective cleaning machine;
(v) a wear on the respective cleaning machine;
(vi) a noise generated by the respective cleaning machine;
(vii) or a combination thereof.

The cleaning performance of the respective cleaning machine may be, for example, a parameter, which is indicative of whether the cleaning machine has suitable cleaning features to remove the soiling that is present. For example, a cleaning machine designed for cleaning windows cannot remove soiling from a carpet and vice versa.

The consumption of materials by the respective cleaning machine may relate to a cleaning agent and/or care agent to be used by the cleaning machine, for example, or a vacuum cleaner bag, in which dirt removed from a surface by one of the at least two cleaning machines is collected, or additionally or alternatively, wear and tear for cleaning and/or care of the material used by the respective cleaning machine, such as a brush or a clean cloth.

The energy consumption of the respective cleaning machine, for example, may relate to a parameter, which is indicative of how much energy must be applied to eliminate soiling from the respective cleaning machine. A calculation may be carried out in this regard, for example, to ascertain whether the energy status of a respective cleaning machine is sufficient to eliminate a certain soiling. Accordingly, the planning information may also be determined at least partially based on the energy status of the respective cleaning machine.

The wear on the respective cleaning machine may involve, for example, a parameter, which is indicative of how much wear is to be expected in the case of a cleaning features (e.g., a brush or a cleaning cloth) used for cleaning and/or care of the cleaning machine. For example, if a cleaning cloth of a cleaning machine is already soiled due to a previous use, such that elimination of additional soiling is presumably no longer to be expected, then the cleaning may take place more efficiently accordingly, i.e., more rapidly, and/or the cleaning performance can be improved by using the at least two cleaning machines.

The noise generated by the respective cleaning machine, for example, may relate to a parameter, which is indicative of how much noise generation is to be expected in elimination of soiling. For example, according to a specification predefined by a user, it can be stipulated that extremely noisy cleaning and/or care operations, such as vacuum cleaning and/or lawnmowing, are not carried out on days or at times of the day that would have a negative effect on the user or on other people.

In an exemplary embodiment of the method according to the first aspect, the location and/or area to be cleaned and/or cared for within the area to be cleaned and/or cared for is a surface in a house (e.g., a floor, a carpet and/or a window) or in a garden (e.g., lawns, paths, terraces, balconies and/or swimming pool).

According to an exemplary embodiment of the method according to the first aspect, at least the determination of the control information is carried out and/or controlled by a processing unit, wherein the processing unit is in particular arranged centrally in the household or at a decentralized location.

For the case when the processing unit is arranged centrally, the processing unit is a home PC or a server, for example, arranged in the household, or a server cloud arranged in the household.

For the case when the processing unit is arranged decentrally, the processing unit is arranged, for example, inside the household (e.g., when it is comprised of at least one cleaning machine, or comprised of one (mobile, for example) smart device) or arranged outside of the household (e.g., when it is comprised of a server or a server cloud).

The arrangement of the processing unit may be, for example, an installation or a supply as a service, for example, from a third party.

According to an exemplary embodiment of the method according to the first aspect, the position information or orientation information is captured by a camera or by a sensor.

The sensor may be comprised of the respective cleaning machines. The sensor may be, for example, a GPS sensor, which is available in particular in outdoor scenarios, in which the determination of position information and/or orientation information can be ensured by the GPS sensor. Alternatively or additionally, the GPS sensor may be designed as a differential GPS sensor, for example. The sensor may be, for example, an acceleration sensor, a gyroscope, a compass sensor or a module for receiving ambient data for the purpose of determining the position and/or orientation of a respective cleaning machine (e.g., a radar module or a lidar module), in particular in the form of captured position information and/or orientation information.

The sensor may be, for example, a multi sensor, which may comprise in particular a plurality of the aforementioned sensors. Alternatively, a plurality of individual ones of the aforementioned sensors may also include a respective cleaning machine.

The camera may be a camera sensor, for example. The camera and/or the camera sensor may capture image information, for example.

In an exemplary embodiment of the method according to the first aspect, the camera is arranged in such a way that the area to be cleaned and/or cared for is captured by the camera, wherein the determination of the position information and/or orientation information of the least two cleaning machines and/or the acquisition of the soiling information is/are carried out and/or controlled at least partially based on information capture by the camera. For example, image information may be acquired by the camera, wherein the image information can be evaluated by using a suitably adapted algorithm (e.g., stereo vision, SLAM (SLAM=self localization and mapping), visual odometry range, to name a few examples). Position information and/or orientation information can be determined by at least one of the at least two cleaning machines, based at least partially on this evaluated image information. For example, a SLAM algorithm may be used. The SLAM algorithm may optionally be used, for example, by using a Kalman filter, a particle filter, an EM algorithm and/or a graph-based technique in order to be able to determine the most accurate possible position information and/or orientation information.

Local maps, in particular maps of interior rooms, for example, can be used as mapping and orientation tools, such as the SLAM algorithm. For example, position information about objects—both stationary and mobile objects—can be detected in the local maps. In addition, image information or shape information about objects or surfaces, for example, can be stored and assigned to the position information, to create a so-called inventory list. The inventory list may be indicative of a position of an object in an interior room, for example. A determination of the control information may be made, based at least partially on this inventory list, for example.

According to an exemplary embodiment of the method according to the first aspect, the position information and/or orientation information is determined, based at least in part on information detected by a sensor of one of the at least two cleaning machines. The sensor may be, for example, an acceleration sensor, a gyroscope, a compass sensor or a module for receiving ambient data for the purpose of determining the position and/or orientation of a respective cleaning machine (e.g., a radar module or a lidar module), in particular in the form of captured position information and/or orientation information.

In one exemplary embodiment of the method according to the first aspect, the method also comprises the following method steps:
detecting at least one voice command, which is indicative of at least one parameter, on the basis of which the control information is determined;
determining the control information, based at least partially on the at least one voice command detected.

The voice command can be input by a user, for example, via a voice communication interface (e.g., an electronic device, which includes a microphone or the like). The voice command input can be processed locally by the voice communication interface, for example, or a server. For processing on the part of a server, the voice command can also be transmitted over a communication link of the electronic machine to a server after input, for example. It is possible for the voice command input to be processed by voice recognition software (e.g., Apple's Siri or Amazon's Echo or the like). It may be necessary to install additional software for this purpose. A voice command processed in this way can be converted into control information, for example, which can be evaluated, processed, forwarded or otherwise used by the electronic device and/or another electronic device (e.g., a cleaning machine).

According to the second aspect of the present disclosure, an alternative device is also described, comprising at least one processor and at least one memory with computer program code, wherein the at least one memory and the computer program code are equipped to execute and/or control at least one method according to the first aspect by using the at least one processor. The processor should be understood to be, for example, a control unit, a microprocessor, a microcontrol unit, such as a microcontroller, a digital signal processor (DSP), an application-specific integrated circuit (ASIC) or a field-programmable gate array (FPGA).

For example, an exemplary device also comprises features for storing information, such as a program memory and/or a main memory. For example, an exemplary device as contemplated herein also includes features for receiving and/or transmitting information over a network, such as a network interface. For example, exemplary devices as contemplated herein are and/or can be connected to one another via one or more networks.

An exemplary device according to the second aspect is or includes a data processing system, for example, which is set up with regard to software and/or hardware to be able to execute the respective steps of an exemplary method according to the first aspect. Examples of a data processing system include a computer, a desktop computer, a server, a thin client and/or a portable computer (mobile device) such as a laptop computer, a tablet computer, a wearable, a personal digital assistant or a smartphone.

According to the second aspect of the present disclosure, a computer program is described, comprising program instructions, which prompt a processor to execute and/or control a method according to the first aspect when the computer program is running on the processor. An exemplary program as contemplated herein may be stored in or on a computer-readable memory medium containing one or more programs.

According to the second aspect of the present disclosure, a computer-readable memory medium is also described, including a computer program according to the second aspect. A computer-readable memory medium may be designed as a magnetic, electric, electromagnetic, optical and/or other type of memory medium, for example. Such a computer-readable memory medium is preferably designed to be “touchable” in the present case, for example, being designed as a data carrier device. Such a data carrier device is portable, for example, or is permanently installed in a device. Examples of such a data carrier device include volatile or nonvolatile random access memories (RAM), for example, NOR flash memories or those with sequential access such as NAND flash memories and/or memories with read-only access (ROM) or write-read access. Computer-readable should be understood to mean, for example, that the memory medium can be read (out) and/or written by a computer and/or a data processing system, for example, being read out or written by a processor.

In an exemplary embodiment of the of the present disclosure according to all aspects, for example, a system, a group including two or more homogenous cleaning machines (e.g., robots and/or drones) designed for autonomous operation for cleaning the usual surfaces in households (e.g., floors, windows), for cleaning surfaces in swimming pools or for care of a lawn surface and have the functionality of self-propagation in a two-dimensional space by means of a roller drive or a caterpillar drive. Additional types of propagation are also conceivable in addition to the examples given above.

In another exemplary embodiment of the present disclosure according to all aspects, for example, a system, a group including two or more homogenous cleaning machines (e.g., robots and/or drones) designed for autonomous operation for cleaning the usual surfaces in households (e.g., floors, windows), for cleaning surfaces in swimming pools, or for care of a lawn surface; these machines have the functionality of self-propagation by a jet propulsion drive, moving rotors, magnetic or electromagnetic fields or some other mechanism in a three-dimensional space. Additional types of propulsion are also conceivable in addition to the examples given above.

Each individual cleaning machine (e.g., robot and/or drone) may have one or more sensors, for example, wherein the one or more sensors include, for example, one of the sensors listed below: (i) a laser distance meter; (ii) an infrared camera; (iii) a gray-scale camera; (iv) an RGB camera; (v) an RGBD camera (depth camera); (vi) a TOF (TOF time of flight) camera; (vii) a resistance sensor; (viii) an ultrasonic sensor; (ix) a dirt sensor; (x) an odor sensor; (xi) a hyperspectral camera; (xii) other sensors for recording relevant data for the purpose of cleaning and/or care; (xiii) or a combination thereof.

In an exemplary embodiment of the present disclosure according to all aspects, for example, a system, each individual cleaning machine (e.g., a robot and/or a drone) may have a processing unit, which can analyze captured (e.g., recorded) information (e.g., data) and can determine parameters that are relevant for cleaning and/or care (these parameters being covered by control information). The processing unit may have, for example, a method of making a decision about a cleaning and/or care procedure to be employed. The processing unit may, for example, automatically prompt a cleaning and/or care of an area with or without addition of auxiliary features and/or may prompt the carrying out of this method.

In another exemplary embodiment of the present disclosure according to all aspects, for example, a system, information about soiling, for example, may be forwarded to a home appliance controller installed in the household (e.g., a desktop computer, a central control unit, a server, a home automation system, to name a few examples) or a smart device that is mobile, for example (e.g., a smartphone, a tablet, a smartwatch, to name a few examples) which can display and monitor, for example, the progress of a cleaning and/or care procedure, and can be monitored via a wireless communication unit (e.g., WLAN, WAN, Zigbee, Bluetooth, to name a few examples).

In an exemplary embodiment of the present disclosure according to all aspects, for example, a system, for example, each cleaning machine (e.g., robot and/or drone) may not have its own processing unit but instead may have only a wireless communication interface (e.g., WLAN, Zigbee, Bluetooth, to name a few examples), wherein acquired (e.g., captured) information (e.g., sensor data acquired by one or more sensors) can be transmitted to a home appliance controller (e.g., a desktop computer, a central control unit, a server, a home automation system, to name a few examples) arranged centrally in a household (e.g., installed there) via a communication interface, a mobile smart device, for example, (e.g., a smartphone, a tablet, a smartwatch, to name a few examples). The home appliance controller arranged in the household or the mobile smart device can carry out, for example, the processing of the information transmitted from the cleaning machine for detecting the presence or absence of soiling or for determining the nature of the soiling or the like, for example. The home appliance controller arranged in the household or the mobile smart device may have a method of making a decision about a cleaning and/or care procedure to be employed, for example, and can transmit a suitably determined cleaning and/or care procedure to the cleaning machine.

In another exemplary embodiment of the present disclosure according to all aspects, for example, a system, a single cleaning machine (e.g., a robot and/or a drone), for example, may have a number of sensors and communication modules, such as, for example, GPS (GPS global positioning system), differential GPS, accelerometer, gyroscope, compass module, WiFi, WAN, Zigbee, Bluetooth, GPRS (GPRS: general packet radio service), LTE (LTE: long term evolution), 3G (3G: mobile radio system of the third generation (3G-mobile radio system)) or modules to receive ambient data for the purposes of orientation and/or positioning (e.g., radar or lidar systems) of the respective machine and the respective cleaning area or a combination thereof. Non-satellite-based orientation systems, which are suitable for indoor orientation in particular, for example, are also preferred.

In an exemplary embodiment according to all aspects, for example, a system, for example, the processing unit may have an algorithm for autonomous determination of the position and/or orientation of the cleaning machine (e.g., robot and/or drone) with respect to its operative environment. For example, with the help of selection of available information (e.g., information such as measured data acquired from one or more sensors) from an existing camera sensor, for example, and using a suitably adapted algorithm (e.g., stereo vision, SLAM (SLAM: self-localization and mapping), visual odometry range, to name a few examples); such an autonomous determination of the position and/or orientation of the cleaning machine can be accomplished with the help of a selection of available information. It is possible accordingly to detect position information and/or orientation information. A SLAM algorithm may optionally be implemented by using a Kalman filter, a particle filter, an EM algorithm and/or a graph-based technique, for example.

All the mapping and orientation tools may be used, for example, to draft local maps, in particular those of interior spaces. These include, for example, position data on objects, including those that are mobile. Furthermore, image data or shape data of objects or surfaces, for example, may be stored and associated with position data to set up a so-called inventory list, which is indicative of a position of the object in the interior space, for example, and on which a determination of the control information, for example, can be based at least in part.

In an exemplary embodiment of the present disclosure according to all aspects, for example, a system, the processing unit may have an algorithm for determining the position and/or orientation of a cleaning machine (e.g., robot and/or drone), for example, which can be used in the exterior field, for example. For example, the position and/or orientation of the cleaning machine can be determined at least partially based on information, for example, data that can be acquired from one or more GPS sensors, differential GPS sensors, accelerometers, gyroscopes, compass modules, or a combination thereof.

In another exemplary embodiment of the present disclosure according to all aspects, for example, a system, a number of one or more installed Bluetooth transceivers in stationary mounts in and around a cleaning and/or care area, in particular in the interior area of the household, for example, may be used, wherein the Bluetooth transceivers can each emit so-called Bluetooth beacons, for example. Through a processing unit, for example, the respective position and/or orientation of the respective cleaning machines can be determined by using an algorithm to determine the position and/or orientation of at least two cleaning machines (e.g., robot and/or drone) with regard to the respective operative environment by Bluetooth triangulation on the basis of differences in the received signal strength (RSS) of the Bluetooth beacons emitted.

In an exemplary embodiment of the present disclosure according to all aspects, status information is obtained (e.g., determined). The status information can be output, for example, or its output can be triggered.

For example, in a system, each cleaning machine (e.g., robot and/or drone) may have a wireless communication interface (e.g., WLAN, WAN, Zigbee, Bluetooth, to name a few examples) for transmission of status information. The status information can be transmitted, based on a request, to a home appliance controller (e.g., a desktop computer, a central control unit, a server, a home automation system) installed centrally in a household and/or a (mobile, for example) smart device (e.g., a smartphone, a tablet, a smartwatch, to name a few examples). The status information can be output, for example, being displayed for a user on a display device of the smart device.

The status information may be, for example, indicative of a cleaning and/or care action and may optionally also be indicative of a respective position information and/or orientation information and/or indicative of the position and/or orientation of the cleaning machine. Alternatively or additionally, the status information may be indicative of progress, termination, conclusion, starting or some other status of a cleaning operation (e.g., window cleaning, floor cleaning, pool cleaning or a combination thereof) or of a care operation (e.g., mowing the lawn). Alternatively or additionally, the status information may be indicative of properties of the cleaning machine, such as the energy status, material status, material consumption, to name a few non-limiting examples.

The home appliance controller installed centrally in the household or the smart device may carry out, for example, a determination of the movement of individual cleaning machines over a period of time and/or to implement the triggering thereof. The individual cleaning machines may transmit corresponding status information to the home appliance controller installed centrally in the household and/or to the smart device. Alternatively or additionally, the home appliance controller installed centrally in the household or the smart device may detect, for example, the position information and/or orientation information of the respective cleaning machines. For example, historical data can be acquired and evaluated by acquisition over time, for example, in order to be able to determine a prediction or the like based on this historical data, in order to be able to further improve the cleaning result achieved by the cleaning machines. The home appliance controller installed centrally in the household or the smart device can enable concentrated use of the respective cleaning machines, for example, based at least in part on the respective position information and/or orientation information and optionally based on the additional information acquired. Corresponding control information for accelerated and optimized cleaning of a monitored cleaning area and/or care area in the household can be determined by avoiding cleaning and/or care procedures in cleaning and/or care areas that have already been cleaned and/or cared for and/or by using a plurality of cleaning machines at the same time in larger cleaning and/or care areas in the household and/or areas with greater soiling. The control information determined can be transmitted to the respective cleaning machines, for example. Based on the control information transmitted, the respective cleaning machines may carry out a corresponding cleaning and/or care operation, for example.

In another exemplary embodiment of the present disclosure according to all aspects, for example, a system, a cleaning machine can transmit energy status information, for example, as indicative of the energy status of the cleaning machine to a home appliance controller (e.g., a desktop computer, a central control unit, a server, a home automation system) installed centrally in the household or to a (mobile, for example) smart device (e.g., a smartphone, a tablet, a smartwatch, to name a few examples). The home appliance controller installed centrally in the household or the smart device, for example, can determine control information, which is determined at least in part based on the energy status information. For example, in determining the control information, a cleaning and/or care operation on an area, said operating having been accelerated and optimized with regard to the energy technology, can be taken into account in determining the control information; this is accomplished by the fact that, for example, areas that have already been cleaned and/or cared for by the home appliance controller installed centrally in the household or the smart device are excluded, and particularly soiled areas and/or those requiring care are processed jointly by a plurality of cleaning machines, for example.

In an exemplary embodiment of the present disclosure according to all aspects, for example, the respective cleaning machines (robots and/or drones) can determine, independently of one another, the marking information, wherein the marking information is indicative of an area in the household to be cleaned and/or cared for, which is then cleaned and/or cared for by another cleaning machine. An exemplary application case occurs when there is a dwindling energy status of the cleaning machine that determines the marking information, or when the cleaning and/or care equipment of the cleaning machine has little or no suitability for the type of soiling found in the area of the household should be cleaned and/or cared for.

In another exemplary embodiment of the present disclosure according to all aspects, for example, a system, one or more monitoring cameras in stationary mounts in and around a cleaning and/or care area, for example, may be used, wherein the monitoring cameras can capture the cleaning and/or care areas. The monitoring cameras may each have, for example, a wireless communication interface (e.g., WLAN, WAN, Zigbee, Bluetooth, to name a few examples). For example, information acquired by the respective monitoring cameras (e.g., acquired image information) can be transmitted over the wireless communication interface to a home appliance controller installed centrally in the household (e.g., a desktop computer, a central control unit, a server, a home automation system) or a (mobile, for example) smart device (e.g., a smartphone, a tablet, a smartwatch, to name a few examples). The home appliance controller or the smart device can, for example, acquire information from individual cleaning machines (e.g., robots and/or drones) and/or determine position information and/or orientation information with respect to the respective cleaning machines based at least partially on the information acquired from the one or more monitoring cameras by using an algorithm.

In another exemplary embodiment of the present disclosure according to all aspects, for example, a system, it is possible by using a home appliance controller installed centrally in the household (e.g., a desktop computer, a central control unit, a server, a home automation system) or a (mobile, for example) smart device (e.g., a smartphone, a tablet, a smartwatch, to name a few examples) and an algorithm, for example, to determine the control information at least partially based on optimized planning of a movement pattern of a cleaning machine (e.g., a robot and/or drone) and so-called path planning can be determined in the manner of the traveling salesman problem. Accordingly, with respect to the energy to be consumed by the cleaning machine and/or the amount of time required by the cleaning machine, for example, optimized coverage of an area in the household to be cleaned and/or cared for can be achieved through the sum of the cleaning machines used for the corresponding cleaning and/or care.

In another exemplary embodiment of the present disclosure according to all aspects, for example, a system, it is possible to connect a home appliance controller installed centrally in the household (e.g., a desktop computer, a central control unit, a server, a home automation system) or a (mobile, for example) smart device (e.g., a smartphone, a tablet, a smartwatch, to name a few examples) to a cloud over an interface (e.g., LTE, 3G, GPRS, Ethernet, to name a few examples). Status information can be transmitted over the cloud, for example, to a predefined address information (e.g., telephone number, SMS, email, WhatsApp, Skype, to name a few examples). In this way, for example, a user can be informed about the progress, termination, conclusion, start or another status of a cleaning operation (e.g., window cleaning, floor cleaning, pool cleaning or a combination thereof) or a care operation (e.g., mowing the lawn). Such status information can be requested, for example, by the home appliance controller installed centrally in the household and/or directly of a (mobile, for example) smart device. The query about status information may be in response to a request by a user (e.g., through user input). Additionally or alternatively, the home appliance controller installed centrally in the household and/or the smart device can automatically inquiry about the status information. The status information obtained as a result of the query, in particular current status information, can be stored, for example, in a database, to which the smart device and/or home appliance controller installed centrally in the household can have access (e.g., via a communication link).

The determination of the control information may take place, for example, in a home appliance controller installed centrally in the household (e.g., a desktop computer, a central control unit, a server, a home automation system) or in a (mobile, for example) smart device (e.g., a smartphone, a tablet, a smartwatch, to name a few examples). In this case all the cleaning machines can communicate with the home appliance controller installed centrally in the household or with the smart device, for example, via a bidirectional wireless communication. The home appliance controller installed centrally in the household or the smart device may coordinate, for example, all the cleaning machines present in the household, for example, by the control information thereby determined. The home appliance controller installed centrally in the household or the smart device act as a type of master device while each of the cleaning machines acts as a type of slave device. For example, if the computing power of the home appliance controller installed centrally in the household or the smart device is limited, the necessary computing power for operation of the cleaning machines (as a swarm) can be enhanced by a connection to a server-based system or a cloud-based system. For example, this may be necessary if a high computing power is required for individual computation steps, such as processing of image information. Then this information need not be kept on hand in the household but instead can be requested as needed and accessed accordingly.

In another exemplary embodiment according to all aspects of the present disclosure, for example, computing power can be reserved locally for the cleaning machines. For example, the respective cleaning machines may comprise accordingly a processor and a memory in order to able to carry out individual computation steps. This may be relevant, for example, if no connection to a server or cloud is available or if communication with a server or cloud is impossible because of spatial factors or communication with a server or a cloud is not desired on the part of the user. In addition in a swarm of at least two cleaning machines, for example, the computing power may be divided among different cleaning machines. Accordingly, each cleaning machine need not necessarily have the corresponding equipment (e.g., processor and memory). It is thus possible to split computation procedures, for individual computation steps to be determined in parallel on the part of at least two cleaning machines and then combined again into one overall result.

One exemplary embodiment according to all aspects of the present disclosure provides that a swarm of at least two cleaning machines will have at least one voice communication interface by which voice commands by a user can be transmitted directly to the swarm via an additional device (e.g., a smartphone or the so-called Echo device from the manufacturer Amazon or the like). Alternatively, the voice commands are input on the part of a cleaning machine that has a voice communication interface, for example. The voice command thereby entered can be converted into control information by having the determination of the control information take place and/or be carried out at least partially based on the input voice command. Accordingly, the entire swarm or, alternatively, a portion of the swarm can be controlled by the user's voice command. For example, parts of a location or an area in the household to be cleaned and/or cared for (e.g., kitchen) may be cleaned and/or cared for on the basis of a voice command input by the user, in which case, for example, the entire capacity of the swarm of cleaning machines should not, i.e., need not be used for the corresponding cleaning and/or care operation. One or more voice commands may be associated with the inventory list, for example (e.g., voice command: “Clean window, south side!”). An action associated with the voice command may be carried out directly and/or its implementation may be triggered based on position information and/or orientation information from the respective cleaning machines and optionally based on an unambiguous association of a name for an area in the household to be cleaned and/or cared for.

The exemplary embodiments described previously in this description should also be understood as being disclosed in all combinations with one another. In particular, exemplary embodiments should be understood as disclosed with respect to the different aspects.

In particular, corresponding features for carrying out the method steps by the preferred embodiments of a device shall be disclosed by the previous or following description of method steps according to preferred embodiments of a method. Likewise, the corresponding method step shall also be disclosed by the disclosure of features of a device for carrying out a method step.

Additional advantageous exemplary embodiments can be derived from the following detailed description of a few exemplary embodiments, in particular in conjunction with the figures. However, the figures should serve only the purpose of illustration and should not be used to determine the scope of protection. The figures are not drawn true to scale and should only reflect the general concept as an example. In particular, features contained in the figures should by no means be considered to be a necessary component.

### BRIEF DESCRIPTION OF THE DRAWINGS

The present disclosure will hereinafter be described in conjunction with the following drawing figures, wherein like numerals denote like elements, and:

FIG. 1 shows a schematic diagram of one exemplary embodiment of a system according to the third aspect;

FIG. 2 shows a flow chart of one exemplary embodiment of a method according to the first aspect;

FIG. 3 shows a block diagram of one exemplary embodiment of a device according to the second aspect;

FIG. 4 shows a schematic diagram of another exemplary embodiment of a system according to the third aspect;

FIG. 5 shows a schematic diagram of another exemplary embodiment of a system according to the third aspect;

FIG. 6 shows a schematic diagram of another exemplary embodiment of a system according to the third aspect;

FIG. 7 shows a schematic diagram of another exemplary embodiment of a system according to the third aspect; and

FIG. 8 shows a schematic diagram of another exemplary embodiment of a system according to the third aspect.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

The following description serves to deepen one's understanding of the present disclosure and should be understood as a supplement to the general description above and should be read together with it.

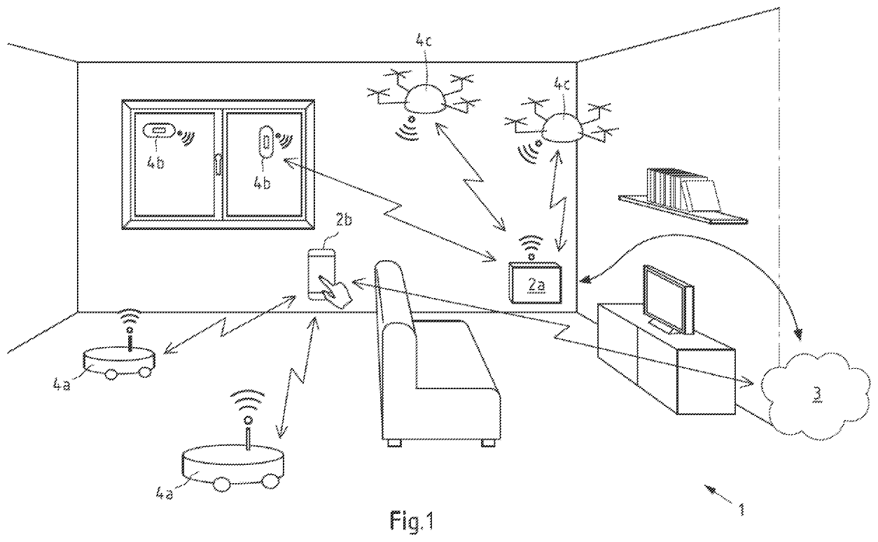

FIG. 1 shows an embodiment of devices according to the second aspect and/or a system 1 according to the third aspect.

The system 1 comprises a plurality of cleaning machines, namely two floor robots 4a, two window robots 4b and two flying robots 4c in the present case. This system also comprises a processing unit, namely a server 2a in the present case, which, alternatively, may also be embodied as a server cloud 3 (e.g., a plurality of servers that are interconnected over the Internet, for example, and together at least partially provide a service). Alternatively or additionally, the processing unit may be a smart device 2b, for example, a smartphone, a tablet, thin client or the like, namely a smartphone in the present case.

According to an exemplary embodiment, position information and/or orientation information, which is supplied subsequently to the processing unit 2a or 2b, for example, can be acquired on the part of the cleaning machines 4a to 4c. The position information and/or orientation information can be transmitted over a wireless communication link, e.g., based on a mobile radio communication, a WAN (wide area network, e.g., LoRa or Sigfox) or on a WLAN (wireless local area network) communication. Accordingly, the cleaning machines 4a to 4c as well as the processing unit 2a or 2b in the present case both have a suitably designed communication interface.

For example, soiling information, which is then supplied to the processing unit 2a or 2b, for example, may be acquired on the part of one of the cleaning machines 4a to 4c.

After receiving at least acquired position information and/or orientation information and acquired soiling information, for example, the processing unit 2a or 2b can determine control information, in which case the control information is determined at least partially based on the acquired information.

The cleaning machines 4a to 4c may be designed, for example, to receive certain control information. Accordingly, control information output on the part of the processing unit 2a or 2b can be received by the respective cleaning machines 4a to 4c. Based on the received control information, the respective cleaning machines 4a to 4c may carry out an action, in particular automatically. The action may comprise the cleaning and/or care to eliminate soiling in particular.

Additional features of the system illustrated in FIG. 1 are explained below in Exemplary Embodiment 1.

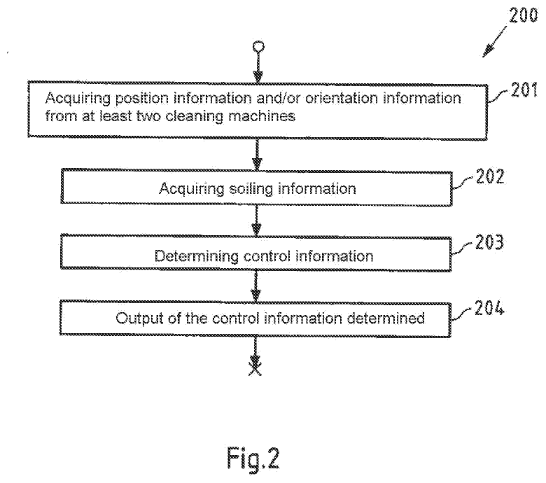

FIG. 2 shows a flow chart 200 of an embodiment of a method according to the first aspect.

In a first step 201, position information and/or orientation information is acquired by at least two cleaning machines, e.g., on the part of the respective cleaning machines 4a to 4c according to FIG. 1, wherein the position information and/or orientation information is indicative of the position and/or orientation of a cleaning machine in an area to be cleaned and/or cared for, e.g., the room according to FIG. 1. The position information and/or orientation information of a respective cleaning machine represents, for example, the position of the two floor robots 4a, the two window robots 4b and/or the two flying robots (drones) 4c according to FIG. 1.

In a second step 202, soiling information is acquired, for example, on the part of the respective cleaning machines 4a to 4c according to FIG. 1 or on the part of a camera (not shown) set up in the room according to FIG. 1, wherein the soiling information is indicative of a location or area to be cleaned and/or cared for, e.g., soiling inside the area to be cleaned and/or cared for. The soiling information represents, for example, soiling of the floor in a room, which is to be eliminated by one of the two floor robots 4a according to FIG. 1.

In a third step 203, control information is determined, e.g., on the part of the processing unit 2a or 2b according to FIG. 1, based at least partially on the acquired position information and/or orientation information and on the acquired soiling information. The control information determined represents, for example, the location (position) of detected soiling, e.g., on the floor, said information being transmitted to a certain cleaning machine, e.g., one of the two floor robots 4a according to FIG. 1, whereupon the selected floor robot 4a removes the soiling from the floor.

In a fourth step 204, the control information determined is output, or the output of the control information is triggered, e.g., on the part of the processing unit 2a or 2b according to FIG. 1.

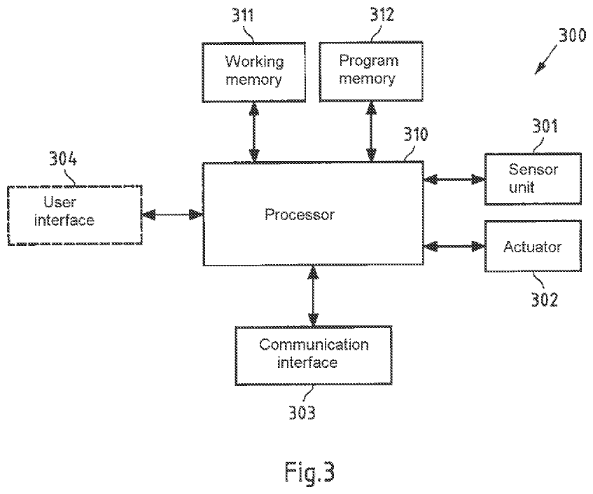

FIG. 3 shows a block diagram of one embodiment of a device 300, which can carry out an exemplary method according to the first aspect. The device 300 is, for example, a device according to the second aspect or a system according to the third aspect. For example, the device is a cleaning machine, (e.g., a robot and/or a drone) or a processing unit (e.g., a home appliance controller arranged centrally in the household or a (mobile) smart device (e.g., a smartphone, tablet, smartwatch) or the like)).

The device 300 may be to this extent, for example, a computer, a desktop computer, a server, a thin client or a portable computer (mobile) such as, for example, a laptop computer, a tablet computer, a personal digital assistant (PDA) or a smartphone. The device may carry out the function of a server or a client, for example. The device 300 may also be suitable for being set up on a cleaning machine, such that control and/or regulation of functions of the cleaning machine is/are possible with the device 300. To do so, the device 300 can be connected to a processing unit, for example, via a hardwired and/or a wireless communication link if the device itself is not a processing unit.

The processor 310 of the device 300 is designed in particular as a microprocessor, a microcontrol unit, a microcontroller, a digital signal processor (DSP), an application-specific integrated circuit (ASIC) or a field-programmable gate array (FPGA).

The processor 310 carries out program instructions, which are stored in program memory 312 and it stores, for example, interim results or the like in working memory or the main memory 311. For example, the program memory 312 is a nonvolatile memory, such as flash memory, a magnetic memory, an EEPROM memory (electrically erasable programmable read-only memory) and/or an optical memory. Main or working memory 311 is, for example, a volatile or nonvolatile memory, in particular a random access memory (RAM), such as a static RAM memory (SRAM), a dynamic RAM memory (DRAM), a ferroelectric RAM memory (FeRAM) and/or a magnetic RAM memory (MRAM).

The program memory 312 is preferably a local data carrier fixedly connected to the device 300. Data carriers fixedly connected to the device 300 include, for example, hard drives installed in the device 300. Alternatively, the data carrier may also be a data carrier that can be detachably connected to the device 300, such as a memory stick, a replaceable data medium, a portable hard drive, a CD, a DVD and/or a diskette.

The program memory 312 contains, for example, the operating system of the device 300, which is loaded at least partially into main memory 311 when initializing the device 300 and is executed by the processor 310. In particular, at least a portion of the core of the operating system is loaded into the main memory in initializing the device 300 and is executed by the processor 310. The operating system of device 300 is a Windows, UNIX, Linux, Android, Apple iOS and/or MAC operating system, for example.

The operating system permits in particular the use of the device 300 for data processing. It manages process features, such as main memory 311 and program memory 312, an optional network interface, an input and output device, e.g., the optional user interface 304, makes available basic functions to other programs through programming interfaces and controls the execution of programs.

The processor 310 controls the communication interface 303, which may be a network interface, for example, and may be designed as a network card, network module and/or modem. The communication interface 303 is equipped in particular to establish a connection of the device 300 to other devices, in particular via a (wireless) communication system, for example, a network, and to communicate therewith. The communication interface 303 may receive data (via the communication system), for example, and forward the data to processor 310 and/or receive data from processor 310 and transmit the data (via the communication system). Examples of a communication system include a local area network (LAN), a wide area network (WAN), a wireless network (according to the IEEE-802.11 standard, for example, the Bluetooth (LE) standard and/or the NFC standard), a hardwired network, a mobile radio network, a telephone network and/or the Internet.

In addition, the processor 310 may control at least one optional user interface 304. Input/output device 314 is a keypad, a mouse, a display unit, a microphone, a touch-sensitive display unit, a loudspeaker, a reader, a drive and/or a camera, for example. The optional user interface 304 may receive a user's input, for example, and forward it to processor 310 and/or receive output information for the user from processor 310.

The device 300 additionally comprises a sensor unit 301, an actuator 302 and a user interface 304. The sensor unit 301 may have, for example, a corresponding sensor for acquiring the position information and/or orientation information and for acquiring soiling information. The actuator 302 can actuate a cleaning feature of the device 300, for example.

Additional exemplary embodiments, which can be carried out by devices according to the second aspect and/or the system 200 according to the third aspect, for example, are described below.

### Exemplary Embodiment 1

In an exemplary embodiment according to the present disclosure, for example, the system 1 illustrated in FIG. 1, the quantity of robots 4a to 4c include drones 4a, which are situated on the floor in interior rooms and are used for cleaning the floor area, a quantity of drones 4b provided for cleaning window areas and drones 4c, which can move through the air, such that all these robots 4a to 4c communicate with a central processing unit 2a and/or 2b or a cloud 3 via a wireless communication interface, e.g., communication interface 303 according to FIG. 3, and wherein these robots 4a to 4c either process sensor data recorded automatically, e.g., acquired by the sensor unit 301 according to FIG. 3, or they transmit this data for processing to a central processing unit, e.g., 2a or 2b or the cloud, and said robots perform an optimized cleaning of an object or surroundings and/or trigger such an action by the actuator 302 of the device according to FIG. 3 on the basis of the processed data and control information that is determined. In addition, information, e.g., the control information determined, can be transmitted to a user, and more extensive control information, which is input by the user, for example, can be transmitted at least to one of the quantity of robots 4a to 4c or for processing to the central processing unit, e.g., 2a or 2b, or to the cloud 3.

### Exemplary Embodiment 2

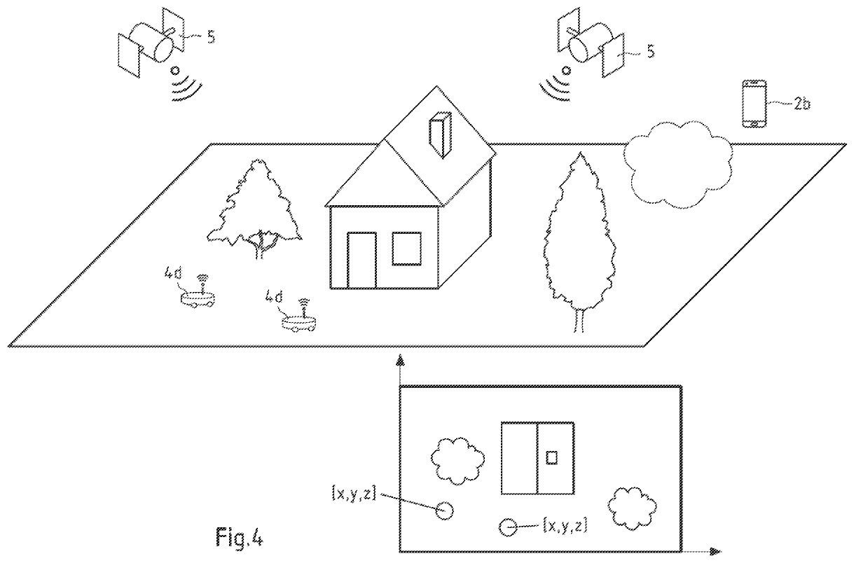

In another exemplary embodiment according to the present disclosure, illustrated in FIG. 4, for example, the quantity of drones 4d includes one or more robots to be used automatically for care of plants growing in the outdoor area, said robots being connected by a wireless communication interface, e.g., communication interface 303 according to FIG. 3, to a cloud and/or a processing unit and/or a user's smart device 2b, and said robots have sensors, e.g., sensor unit 301 according to FIG. 3 for positioning in the outdoor area with the help of differential GPS (GPS: global positioning system) or GPS (represented by the satellites 5, for example), by which their position and orientation in the global coordinate system can be determined and thus also fixed in a local coordinate system, and said sensors are used in a concentrated manner for care of the outdoor area on the basis of their sensor data and processing of the data and control information thereby determined (a type of decision-making). In FIG. 4, the position information and/or orientation information required for this purpose is indicated by the coordinates [x, y, z], which are indicative of the position and/or orientation of the cleaning machines 4d.

### Exemplary Embodiment 3

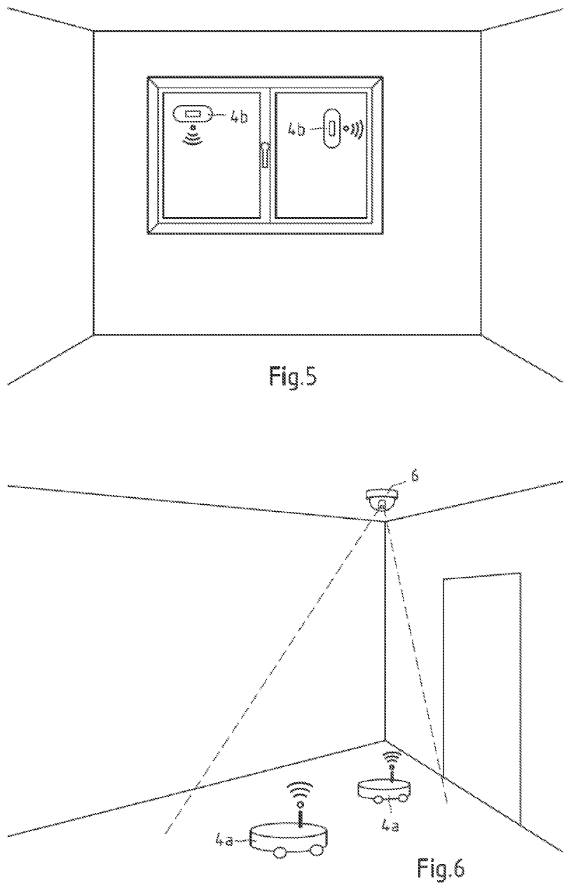

In another exemplary embodiment according to the present disclosure, illustrated in FIG. 5 as an example, the quantity of robots 4b involves fixedly installed window cleaning devices, which communicate with a central processing unit, e.g., processing unit 2a or 2b according to FIG. 1 via a wireless communication interface, e.g., communication interface 303 according to FIG. 3, and which carry out a cleaning using or omitted special cleaning methods and essences based on the self-captured soiling or soiling captured by the central processing unit.

### Exemplary Embodiment 4

In another exemplary embodiment according to the present disclosure, illustrated in FIG. 6, for example, the soiling is captured by one or more sensors mounted on the ceiling, e.g., by the camera sensor 6 shown here, and this data is processed in a central processing unit, e.g., processing unit 2a or 2b according to FIG. 1, and commands for cleaning individual areas are forwarded to a robot, e.g., cleaning device 4a, which then carries out a cleaning using or omitting special cleaning methods and essences.

### Exemplary Embodiment 5

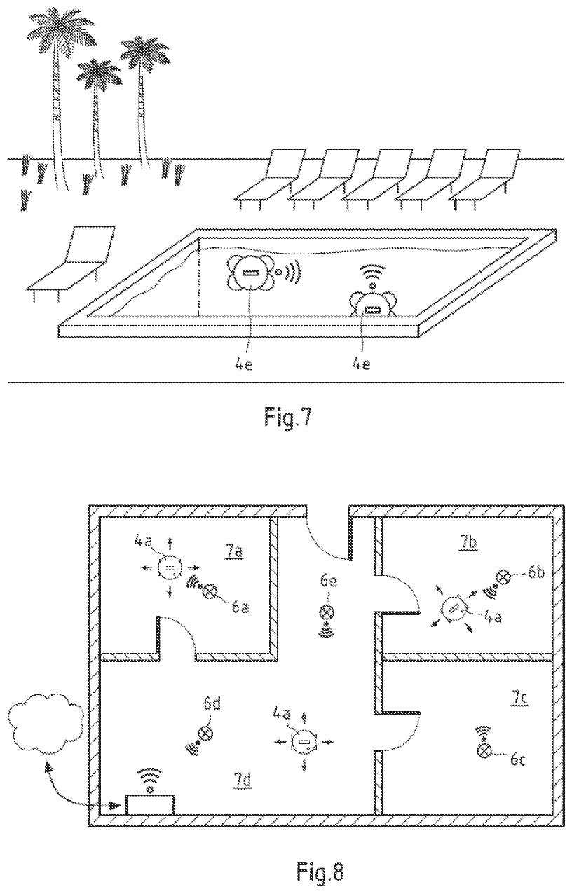

In another exemplary embodiment according to the present disclosure, illustrated in FIG. 7, for example, the quantity of robots refers to drones 4e, which are designed for cleaning a swimming pool, and which are connected to a central processing unit, e.g., processing unit 2a or 2b according to FIG. 1, or to a cloud, e.g., cloud 3 according to FIG. 1 via a communication interface, e.g., communication interface 303 according to FIG. 3, and which automatically capture soiling in the cleaning area and automatically carry out a cleaning.

### Exemplary Embodiment 6

In another exemplary embodiment according to the present disclosure, illustrated in FIG. 8, for example, the quantity of rooms 7a to 7d in a residence is monitored by camera sensors 6a to 6e, which are installed in stationary positions (like the exemplary embodiment described above, illustrated in FIG. 6, for example) and a quantity of drones 4a, namely three cleaning machines in the present case, is controlled for certain areas based on detected soiling by a central processing unit, e.g., processing unit 2a or 2b according to FIG. 1. Next it is possible to carry out a cleaning of the areas determined and/or to trigger the cleaning to be carried out. In the present disclosure, Exemplary Embodiment 5 comprises camera sensors 6a to 6e, wherein the two camera sensors 6d and 6e monitor the room 7d jointly.

The exemplary embodiments of the present disclosure described in this specification and the optional features and properties attached in this regard should also be understood as being disclosed in any and all combinations with one another. In particular—unless stated explicitly to the contrary—the description of a feature included in an exemplary embodiment should not be understood in the present case to mean that the feature is essential or indispensable for the function of the embodiment. The sequence of method steps described in the individual flow charts in this specification is not obligatory, and alternative sequences of the method steps are also conceivable. The method steps can be implemented in a variety of ways, so that implementation in software (through program instructions), hardware or a combination of the two is conceivable for implementation of the method steps.

Terms such as “comprise,” “have,” “include,” “contain” and the like, which are used in the patent claims, do not preclude other elements or steps. The wording “at least in part” includes both the case of “partially” as well as the case of “completely.” The phrase “and/or” should be understood to mean that both the alternative and the combination are to be disclosed, i.e., “A and/or B” means “(A) or (B) or (A and B).” Use of the indefinite article does not preclude a plurality. An individual device can carry out the functions of a plurality of units and/or devices mentioned in the patent claims. Reference numerals given in the patent claims are not to be regarded as restrictions on the means and steps employed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method comprising:
acquiring position information and/or orientation information from at least two cleaning machines, wherein the position information and/or orientation information is indicative of a position and/or orientation of the at least two cleaning machine machines in an area to be cleaned and/or cared for;
acquiring soiling information, such that the soiling information is indicative of a location or area that is to be cleaned and/or cared for within the area to be cleaned or cared for;
determining control information based at least partially on the acquired position information and/or orientation information and on the acquired soiling information; and
outputting or triggering of an output of the control information thereby determined.

2. The method according to claim 1, wherein at least one of the at least two cleaning machines carries out a cleaning and/or care of the location or area based on the control information.

3. The method according to claim 1, wherein the determination of the control information is carried out and/or controlled by a processing unit.

4. The method according to claim 1, wherein the control information determined is output via a communication interface.

5. The method according to claim 1, wherein the soiling information is acquired by one of the at least two cleaning machines.

6. The method according to claim 1, wherein the control information is also determined based on planning information that is determined, wherein the planning information is indicative of predicted locations or areas to be cleaned.

7. The method according to claim 6, wherein the planning information is determined based on at least one of the following parameters:
(i) a cleaning performance of the at least two cleaning machines;
(ii) a material consumption by the at least two cleaning machines;
(iii) a time required by at least two cleaning machines to clean and/or care for the location or area to be cleaned and/or cared for within the location or area to be cleaned and/or cared for;
(iv) an energy consumption by at least two cleaning machines;
(v) a wear on at least two cleaning machines;
(vi) a noise generated by at least two cleaning machines;
(vii) or a combination thereof.

8. The method according to claim 1, wherein the location or area to cleaned and/or cared for within the area to be cleaned and/or cared for is a surface in a house or in a garden.

9. The method according to claim 1, wherein the determination of the control information is carried out and/or controlled by a processing unit, wherein the processing unit is arranged centrally in the household.

10. The method according to claim 1, wherein the position information and/or orientation information is captured by a camera or a sensor.

11. The method according to claim 10, wherein the camera is arranged such that the area to be cleaned and/or cared for is captured by the camera, such that the determination of the position information and/or the orientation information for the at least two cleaning machines and/or the acquisition of the soiling information is carried out and/or controlled at least partially based on information captured by the camera.

12. The method according to claim 1, wherein the position information and/or orientation information is determined at least partially based on information acquired by a sensor from one of the at least two cleaning machines.

13. The method according to claim 1, also comprising:
receiving status information from at least one of the at least two cleaning machines; and
outputting or triggering of an output of the status information.

14. The method according to claim 1, additionally comprising:
acquiring at least one voice command indicative of at least one parameter; and
determining the control information based at least partially on the at least one voice command acquired.

15. A device equipped for carrying out and/or controlling the method according to claim 1.

16. A system comprising:
at least one processing unit and at least two cleaning machines, which together carry out the method according to claim 1.

17. The method according to claim 1, wherein the determination of the control information is carried out and/or controlled by a processing unit, wherein the processing unit is arranged in a decentralized location.
